(19) United States
(12) Patent Application Publication
(10) Pub. No.: US 2011/0029761 A1
(43) Pub. Date: Feb. 3, 2011

(54) Method and apparatus of reducing CPU chip size

(76) Inventors: Chih-Ta Star Sung, Glonn (DE); Chih-Ting Hsu, Jhudong Township (TW); Wei-Ting Cho, Taichung (TW)

Correspondence Address: Chih-Ta Star SUNG;RM. 308. BLD. 52, NO. 195. CHUNG HSING RD., SEC. 4. JHU DONG TOWNSHIP, HSINCHU COUNTY, 310, TW

(21) Appl. No.: 12/462,314

(22) Filed: Aug. 3, 2009

(51) Int. Cl. G06F 9/30

(52) U.S. Cl. 712/228; 712/245; 712/E09.021; 712/E09.023

(57) ABSTRACT

A new compression method and apparatus compresses instructions embedded in a CPU chip which significantly reduces the density of storage device of storing the program. Multiple groups of instructions in the form of binary code are compressed separately by a mapping unit indicating the starting location of a group of instructions which helps quickly recovering the corresponding instructions. A mapping unit is applied to interpret the corresponding address of a group of data for quickly recovering the corresponding instructions for a CPU to execute smoothly.

### BACKGROUND OF THE INVENTION

1. Field of Invention

The present invention relates to the data compression and decompression method and device, and particularly relates to the CPU program memory compression which results in a CPU die area reduction.

2. Description of Related Art

In the past decades, the continuous semiconductor technology migration trend has driven wider and wider applications including internet, mobile phone and digital image and video device. Consumer electronic products consume high amount of semiconductor components including digital camera, video recorder, 3G mobile phone, DVD, Set-top-box, Digital TV, . . . etc.

Some products are implemented by hardware devices, while, another high percentage of product functions and applications are realized by executing a software or firmware program embedded within a CPU, Central Processing Unit or a DSP, Digital Signal Processing engine.

Advantage of using software and/or firmware to implement desired functions includes flexibility and better compatibility with wider applications by re-programming. While, the disadvantage includes higher cost of storage device of program memory which stores a large amount of instructions for specific functions. For example, a hard wire designed ASIC block of a JPEG decoder might costs only 40,000 logic gate, while a total of 128,000 Byte of execution code might be needed for executing the decompression function of JPEG picture decompression which is equivalent to about 1 M bits and 3M logic gate if all instructions are stored on the CPU chip. If a complete program is stored in a program memory, or so called “I-Cache” (Instruction Cache), the memory density might be too high. If partial program is stored in the I-cache, when cache missed, the time of moving the program from an off-chip to the on-chip CPU might cost long delay time and higher power will be dissipated in I/O pad data transferring.

This invention of the CPU instruction sets compression reduces the required density of cache memory which overcomes the disadvantage of the existing CPU with less density of caching memory and higher performance when cache miss happens and also reduces the times of transferring data from an off-chip program memory to the on-chip cache memory and saves power dissipation.

### SUMMARY OF THE INVENTION

The present invention of the high efficiency data compression method and apparatus significantly reduces the requirement of the memory density of the program memory and/or data memory of a CPU.
The present invention reduces the requirement of density and hence the die size of the program memory of a CPU chip by compressing the instruction sets and loading the compressed instruction code to the CPU for decompressing and execution.
When a CPU is executing a program, the I-cache decompression engine of this invention decodes the compression instruction and fills into the “File Register” for CPU to execute the appropriate instruction with corresponding timing.
According to an embodiment of the present invention, the compressed instruction set are saved in the predetermined location of the storage device and the starting address of group of compressed instructions is saved in another predetermined location.
According to an embodiment of the present invention, each group of instructions is compressed separately with no dependency to other group of instructions.
According to an embodiment of the present invention, when a “Branch” command like “JUMP”, “GOTO”, . . . shows up, a group of instructions compression should be terminated and from the next instruction to be executed starts a new group of compression to avoid long delay time of decompressing the compressed instructions.
According to an embodiment of the present invention, when a “Branch” command like “JUMP”, “GOTO”, shows up within a predetermined distance, a group of instructions might include multiple “JUMP”, “GOTO”, . . . commands into a group of compression unit and compress them accordingly.
According to an embodiment of the present invention, a predetermined amount of instructions are accessed and decompressed and buffered to ensure that the “File Register” will not run short of instruction in executing a program.
According to an embodiment of the present invention, a dictionary like storage device is used to store the pattern not shown in previous pattern.
According to an embodiment of the present invention, a comparing engine receives the coming instruction and searches for a matching instruction in the previous instructions.
According to an embodiment of the present invention, a mapping unit calculates the starting location of a group of instruction for quickly recovering the corresponding instruction sets.
According to an embodiment of the present invention, software is applied to compress the instruction sets and saves the compressed code into a storage device, and an on-chip hardware decoder decompresses the compressed code and feeds it into the CPU for execution.

Other aspects and advantages of the present invention will become apparent from the following detailed description, taken in conjunction with the accompanying drawings, illustrating by way of example the principles of the invention. It is to be understood that both the foregoing general description and the following detailed description are by examples, and are intended to provide further explanation of the invention as claimed.

### BRIEF DESCRIPTION OF THE DRAWINGS

FIG. 1 illustrates a prior art of the data flow of a CPU.

FIG. 2 shows the principle and data flowchart of the instruction and data compression within a CPU.

FIG. 3 illustrates a basic concept of compressing a group of instructions into variable length of bits.

FIG. 4 illustrates how a program is partitioned into groups of instruction sets and group by group compressed.

FIG. 5 shows the block diagram of decoding a group of compressed instruction set and how a CPU die can be shrunk by applying a decompression unit.

FIG. 6 illustrates Procedure of Decoding a program and filling the file register for CPU execution.

FIG. 7 illustrates Block diagram of compressing and decompressing the instruction with an address mapping unit.

FIG. 8 illustrates the flowchart of decompressing the compressed instruction sets.

FIG. 9 illustrates how the control signals and data/addr bus are interfacing to the storage device.

### DESCRIPTION OF THE PREFERRED EMBODIMENTS

Due to the fact that the performance of the semiconductor technology has continuously doubled every around 18 months since the invention of the transistor, wide applications including internet, wireless LAN, digital image, audio and video becomes feasible and created huge market including mobile phone, internet, digital camera, video recorder, 3G mobile phone, VCD, DVD, Set-top-box, Digital TV, . . . etc. Some electronic devices are implemented by hardware devices; some are realized by CPU or DSP engines by executing the software or the firmware completely or partially embedded inside the CPU/DSP engine. Due to the momentum of semiconductor technology migration, coupled with short time to market, CPU and DSP solution becomes more popular in the competitive market.

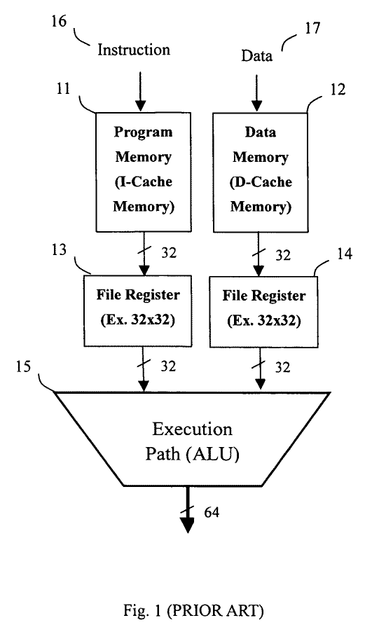

Different applications require variable length of programs which in some cases should be partitioned and part of them is stored in an on-chip “cache memory” since transferring instructions from an off-chip to the CPU causes long delay time and consumes high power. Therefore, most CPUs have a storage device called cache memory for buffering execution code of the program and the data. The cache used to store the program comprising of instruction sets is also named “Instruction Cache” or simply named “I-Cache” while the cache storing the data is called “Data Cache” or “D-Cache”. FIG. 1 shows the prior art principle of how a CPU executes a program. A program is comprised a certain amount of “Instruction” sets 16 and data sets 17 which are the sources and codes of the CPU execution. An “Instruction” instructs the CPU what to work on. The instructions of program are saved in an on-chip program memory, or so called I-Cache memory 11, while the corresponding data which a program needs to execute are saved in an on-chip data memory, or so called D-Cache memory 12. The “Caching Memory” might be organized to be large bank with heavy capacitive loading and relatively slow in accessing compared to the execution speed of the CPU execution logic, therefore, another temporary buffer of so named “File Register” 13, 14 with most likely smaller size, for example 32×32 (32 bits wide instruction or data times 32 rows) is placed between the CPU execution path 15 and the caching memory. The CPU execution path will have some basic ALU functions like AND, NAND, OR, NOR, XOR, Shift, Round, Mod . . . etc, some might have multiplication and data packing and aligning features.

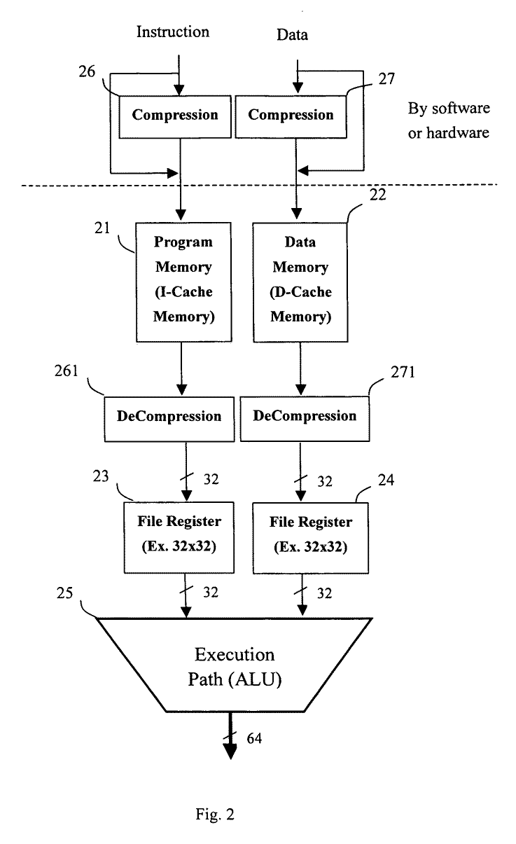

Since the program memory and data memory costs high percentage of die area of a CPU in most applications, this invention reduces the required density of the program and/or data memory by compressing the CPU instruction sets and data. The key procedure of this invention is illustrated in FIG. 2. The instruction sets and/or data is compressed 26, 27 by software or by hardware before being stored into the program memory 21 and data memory 22. When a scheduled time matched for executing the program or data, the compressed instruction and/or data is decompressed 261, 271 and fed to the file register 23, 24 which is a smaller temporary buffer next to the execution unit 25 of the CPU. The instruction or data can also be compressed by other machine before being fed into the CPU engine. If the coming instruction or data is compressed before, then, the compressed instruction or data can bypass the compression step and directly feeds to the program/data memory, said the I-cache and D-cache.

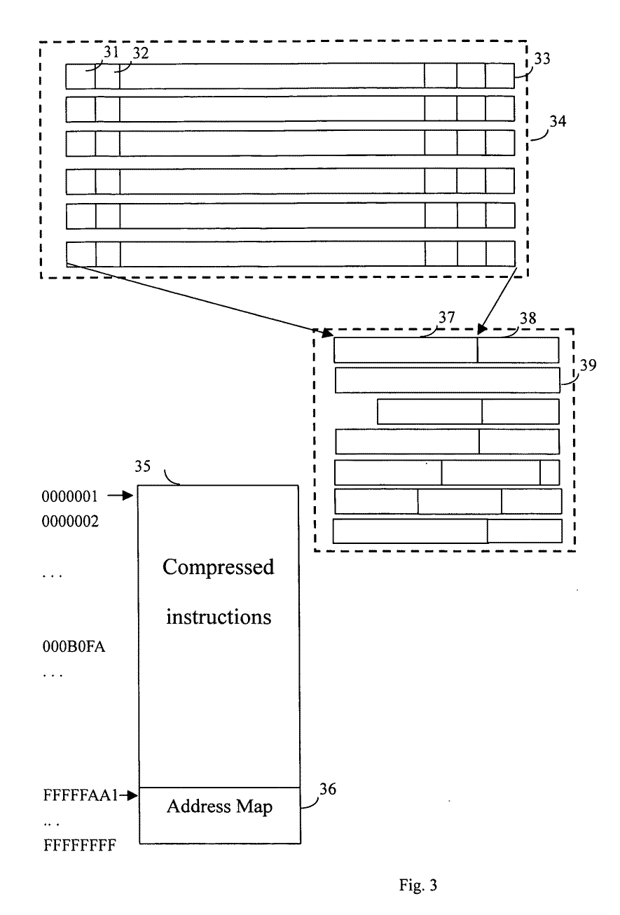

In this invention, the program of instruction sets is compressed before saving to the cache memory. Some instructions are simple, some are complex. The simple instruction can be compressed also in pipelining, while some instructions are related to other instructions' results and require more computing times of execution. Decompressing the compressed program saved in the cache memory also has variable length of computing times for different instructions. The more instruction sets are put together as a compression unit, the higher compression rate will be reached. FIG. 3 depicts the concept of compressing a fixed length of groups of instructions 31, 32, 33 which together form a computer program 34. A group of predetermined amount of instructions can be compressed to be fixed length of code or most likely be variable length of each group 37, 38, 39. A group of instruction sets in this invention is comprised of amount of instruction sets ranging widely from 16 instructions to a couple of thousands of instructions depending on the targeted application. For quick accessing each group of compressed instruction sets, the compressed instruction sets is organized and saved into a storage device with the compressed instructions stored in a predetermined location 35 and the locations of beginning of each group of instructions are saved in another location so named “Address Map” 36. In one of applications of this invention, the compressed instruction set along with the address of the begin of each group of instructions are loaded to an on-chip cache memory or said program memory within a CPU chip, when a CPU executes the instruction sets, the address of begin of each group of compressed instruction sets are read and decoded and the corresponding compressed instructions are loaded to the decompression engine for reconstruction. The decompressed instruction sets then, are fed into the ALU for execution.

Since compression algorithm of this invention compares the target instruction to previous instruction to code the equivalent “pattern” to represent targeted pattern of instruction, all instructions are dependent on previous instruction which in decompression requires reconstructing the previous instructions to be reference for the targeted instruction. Since compression results in variable length of code from instruction to instruction and the location of each compressed instruction is unpredictable. In decoding CPU instruction sets and feeding to the CPU for execution, one of the most critical requirements is to keep the decompressed instruction as uncompressed and fill the register file in timely manner without encountering emptiness of the register file which will results in wrong data fed into the CPU in a scheduled time and fatal errors in execution. One instruction followed by another instruction in compression will in principle smoothly handle the storage of the compressed data and in decompression, there will not cause any error if the compressed instructions are stored in the storage device sequentially. In some cases like Branch instruction with “JUMP”, “GOTO” or other “Conditional” which instruction followed by not the next instruction in execution and the next compressed instructions is saved in unknown location of the storage device will cause error in reconstructing the instruction for execution.

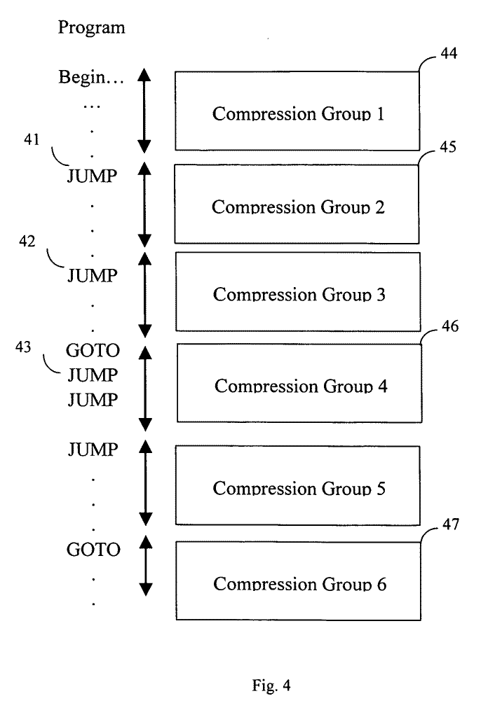

One method to avoid the error of jumping to random location of the compressed instructions is to divide the CPU program into multiple “Groups” of instructions with each group of instruction starting with the first location of a “Branch” instruction which means the next instruction to be executed will not sequentially go to the next one, but go to the address of direct or indirect appointed location for example “JUMP”. “GOTO” “LOOP-RETURN” . . . . Instructions 41, 42, 43 as shown in FIG. 4. When conditional or unconditional JUMP or GOTO instruction happens, a new group 45, 46, 47 of compression unit begins with the first instruction of the next instruction to be executed. And each start of a group of compressed instruction will be saved into a location of memory for quick accessing in decompressing the instructions. When decompressing the compressed instruction, the decoder will reconstruct the instruction sequentially, and when encountering the special cases of Branch instruction like JUMP, GOTO with next location not the next to it, the address map unit will be accessed and tells the decompression engine where to obtain the new group of the compression instruction sets. Some times, a CPU program has multiple Branch instructions in a short distance, and if compression always begins when a Branch instruction happens, the compression ratio will drop since a group of instructions always start with lower compression ratio since there is fewer previous instruction or said pattern which matches and can be used to represent the target instruction.

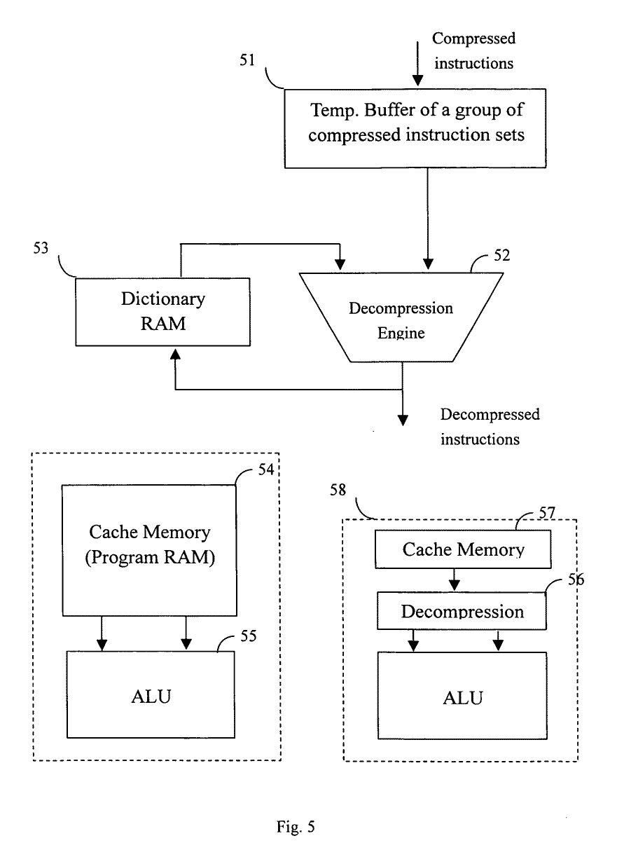

In decompressing the compressed instruction or said the program memory, the compressed instructions stored in a cache memory are accessed and loaded into a smaller temporary buffer 51 as shown in FIG. 5. A decompressing engine 52 is used to reconstruct the compressed instruction by referring the coming target instruction to previous instructions which are stored in a so called “Dictionary” RAM 53. The dictionary RAM is a First In First Out (FIFO) storage device with saving the previously recovered instructions. Since most CPU or controller are comprised of an on-chip cache memory (program RAM) 54 and an ALU 55 execution unit, applying this invention of the instruction compression 56 reduces the density and die area of the cache memory 57 and hence the while CPU die size gets shrunk.

In some applications of this invention of I-cache and/or D-cache memory compression, a program or data sets can be compressed by the built-in on-chip compressor; some can be done by other software executed by another CPU. Both ways of compressing the instruction or data, the compressed program and data set can be saved in the cache memory and decompressed by an on-chip decompression unit. Some instructions random access other instruction or location, for instance, “Jump”, “GOTO”, for achieving higher performance, a predetermined depth of buffer or named FIFO (First in, first out), for example, 32×16 bits is design to temporarily store the instructions, and send the instruction to the compressor for compression. For random accessing the instruction and quickly decoding the compressed instructions, the compressor compresses the instructions with each group of instruction with a predetermine length and the compressed instructions are buffered by a buffer before being stored to the cache memory.

By compressing the requirement of the cache memory which stores the program reduces the die size of a CPU by a factor of 15% to 40% depending on the percentage of the cache memory dominance of the whole CPU size. In a regular compression and decompression procedure for most instructions, the starting address of the storage device saving the compressed is stored in an address map with the first instruction leaving uncompressed “as is” status and the following instructions are compressed by referring to previous instructions.

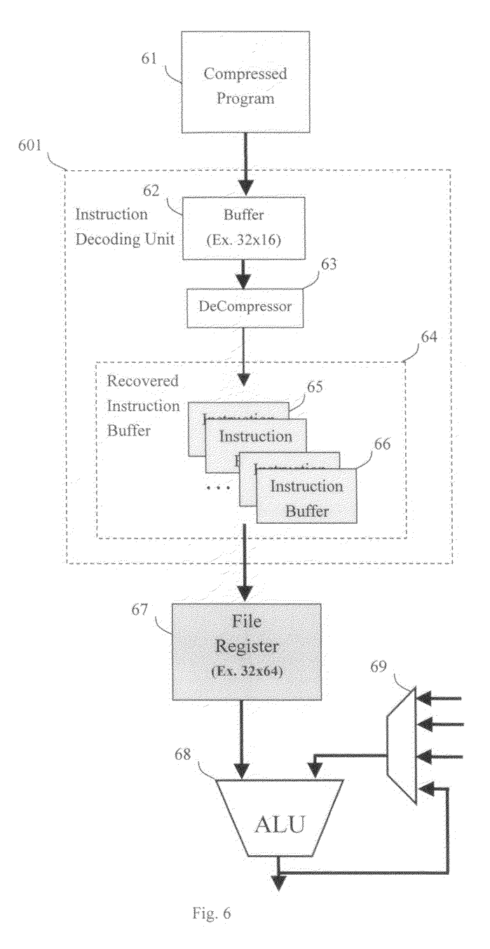

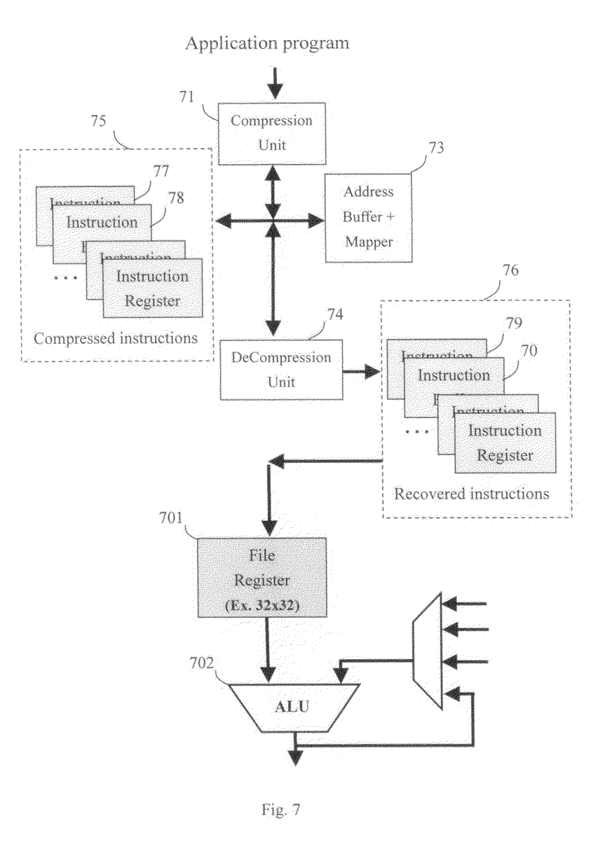

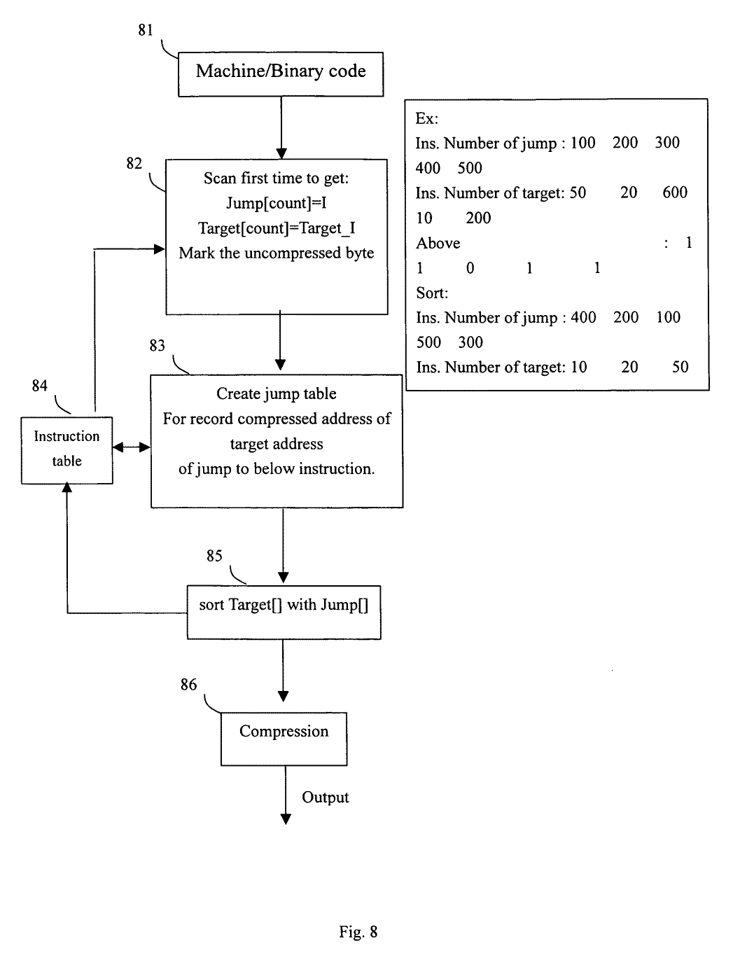

FIG. 6 shows a more special case of the procedure of decompressing the instructions and filling the “File Register” for execution. The compressed instructions stored in the I-Cache memory 61 is input to the Decompressing unit 601 which includes a predetermined amount of buffer 62, for instance, a 32×16 bits, a Decompress or 63 and a predetermined amount of the buffer 65, 66 of recovered instructions 64 or so named FIFO. The recovered instructions are fed into the “File Register” 67 which a temporary buffer before the execution path, or so names ALU, Arithmetic and Logic Unit 68. Some instructions wait the result of previous instruction and combine other data which is selected by a multiplexer 69 to determine which data to be fed to the execution unit again. A complete procedure of compressing and decompressing the instruction set within a CPU is depicted in FIG. 7. An application program with uncompressed instruction sets is compressed 71 and stored into the so named “I-cache” 75 with a predetermined amount of groups of compressed instructions. During compressing, a counter calculates the data rate of each group of compressed instruction and converts it to be starting address of the I-cache memory and saved in an address mapping buffer 73. During decompressing, the compressed instruction sets are accessed by calculating the starting address which is done by the address mapping unit 73. The calculated starting address of a group of instructions will be then accessed and instruction sets are decompressed 74 and temporarily saved in a register array 76 for feeding to the file register 701 in a scheduled timing. The depth of the temporary buffer for saving the decompressed instructions 70, 79 is defined jointly with the file register to ensure the ALU 702 will continuously running instructions without underflow the file register.

Compression procedure of this invention begins with loading the machine code 81 or said a binary code to a temporary storage device, scan and interpret the instructions 82 to search for some “Branch” or said “special command” like JUMP, GOTO . . . and create a table 84 saving the “Branch” commands and the starting address of the new group of instructions 83 followed by the compression step 86 which reduces the data amount by referring the target pattern of instruction. The decompression engine revises this procedure can reconstruct a complete program of instruction sets. The higher the compression ratio, the more storage device can be reduced and the less the die cost of a CPU will be lower accordingly.

FIG. 9 shows the timing diagram of the handshaking of the data-addr and control signals of the compression engine within a CPU. The valid data 93, 94 or address 95, 96 are output by most likely a burst mode with D-Rdy (data valid) 97, 98 and A-Rdy (Address valid) 99, 910 signals with active high enabling. All signals and data are synchronized with the clock 91, 92. With this kind of handshaking mechanism, the storage device or said the I-cache will clearly understand the type and timing of the valid data and starting address of the groups of instructions. The temporary register saving the starting address can be overwritten after the stored address information is sent out to the I-cache. By scheduling outputting the starting address and overwriting the register by new starting address of new groups of compressed instructions, the density of the temporary register can be minimized.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of executing instruction sets of a CPU, comprising:
fetching the instructions to be executed and dividing the instructions into multiple “groups” with each group of instructions having the first instruction not refer to any other instruction;
group by group compressing the instructions sequentially and storing the compressed instructions into the predetermined first location of the first storage device;
calculating the starting location of each compressed group of instructions and saving to the predetermined second location of the first storage device;
fetching the compressed instructions from the first location of the first location by referring to the starting address saved in the second location of the first storage device; and
decompressing instructions and saving into the second storage device which directly connects to the CPU for execution.

2. The method of claim 1, wherein in compressing a new group of instructions, the first instruction is saved into the storage device in the original form of a machine code.

3. The method of claim 1, wherein a group of instruction sets is comprised of at least two instructions with the first instruction uncompressed and the rest of instructions are compared to previous instructions to identify a matched pattern to represent it.

4. The method of claim 1, wherein a temporary storage device comprising of a predetermined amount of registers is used to buffer the decompressed instructions for continuously filling the second storage device for CPU to directly execute the program without running out of instruction.

5. The method of claim 1, wherein during accessing a group of compressed instructions, the starting location which is stored in the second location of the first device is accessed firstly, followed by accessing the codes representing the length of the groups of compressed instructions and the final location of the first compressed instruction saved in the storage device can be calculated and accessed accordingly.

6. The method of claim 1, wherein in compressing an uncompressed program, a temporary storage device comprising of multiple registers are used to buffer the compressed instructions and store to the first storage device which has higher density than the second storage device.

7. The method of claim 1, wherein a program of instructions is divided to be multiple groups of instructions with each group begins when a “Branch” instruction forcing the CPU to execute the next instruction which is not the next instruction.

8. The method of claim 1, wherein in compressing a new group of instructions, the first instruction is compressed by information of itself and saves into the instruction buffer which temporarily stores previous instructions.

9. A method of fast accessing and decompressing the on-chip compressed instructions saved in the so called program memory within a CPU, comprising:
reducing the data rate of instructions group by group by referring current instruction to a temporary buffer which saved previous instructions to check whether there is an instructions which is identical to the current instruction and using it to represent the current instruction;
if no identical instruction in the instruction register, then, compressing the instruction by information of itself and saving the current instruction into the instruction register to be the reference for next instructions in compression;
driving out and conducting at least two signals to the storage device to indicate which output data from the compression unit is the compressed data and which is the starting address of a group of instruction and saving the compressed instructions data into the predetermined location and the starting address of at least one group of compressed instructions into another location of the storage device; and
when continuously accessing and decompressing the compressed instructions, the address mapping unit calculates the starting address of the corresponding group of the compressed instructions and decompressing the instructions and feeding to the file register for execution.

10. The method of claim 9, wherein a predetermined amount of register temporarily used to save the starting address of groups of compressed instructions can be overwritten by new starting address once the starting address of previous group of instructions are output to the storage device.

11. The method of claim 9, wherein saving the compressed instructions into a predetermined location with burst mode of data transferring mechanism and saving the starting address of groups of instructions into another location with the control signals indicating which cycle time has compressed instruction data or starting address on the bus.

12. The method of claim 9, wherein there are at least two signals, one indicating “Data ready” another for “Starting address ready” being connected to the storage device to indicate which type of data are on the bus.

13. The method of claim 9, wherein a mapping unit calculating the starting location of a group of compressed instructions for more quickly recovering the corresponding instructions is comprised a translator which adds the starting address and the decoded length of group or sub-group of instructions to be the exact starting location of the storage device which saves the compressed instructions.

14. The apparatus of claim 9, wherein during decompressing instructions correlating to other instructions, a corresponding group of compressed instructions are accessed and decompressed through the translation of the address mapping unit.

15. The method of claim 9, wherein the compressed instructions data are burst and saved in the predetermined location of the storage device and the starting address of group of instructions is saved from another predetermined location of the storage device.

16. The method of claim 9, wherein, at least two groups of compressed instructions have different length of bits.

17. The method of claim 9, wherein, if “cache miss” happens, the uncompressed instructions saved in the second storage device are transferred and compressed firstly before being saved to the storage device within the current CPU.

18. A method of compressing instructions and saving into the so called cache memory within a CPU, comprising:
fetching instructions in the form of machine or said a binary code from a storage device;
interpreting the machine code into a higher level language of programming and determining whether a “Branch” instruction happens and a new group of compression unit is needed or can continuously compressing the instructions;
if no need of forming a new compression group, then, continuously compressing the machine code; and
if a Branch instruction happens, the next instruction will be fetched and its following instructions to form a new compression group and a compression algorithm will be applied to reduce the data amount of instructions.

19. The method of claim 18 wherein, an interpreter is realized to translate the machine code to so called “Assembly Code” to decide whether there is a “Branch” instruction and needs to create a new group of instruction for compression.

20. The method of claim 18, wherein, an interpreter is realized by software of a CPU machine, and the compressed instruction is input to another CPU for decompressing and being executed.
